(19) United States
(12) Patent Application Publication
(10) Pub. No.: US 2005/0195793 A1
(43) Pub. Date: Sep. 8, 2005

(54) System for locally synchronizing a group of mobile devices

(75) Inventors: Bryan L. Dalton, Endicott, NY (US); Michael A. Heaton, Owego, NY (US); James S. Howard, Apalachin, NY (US); Lynn M. Van Damia, Owego, NY (US)

Correspondence Address: TAROLLI, SUNDHEIM, COVELL & TUMMINO L.L.P., 526 SUPERIOR AVENUE, SUITE 1111, CLEVEVLAND, OH, 44114, US

(73) Assignee: Lockheed Martin Corporation

(21) Appl. No.: 11/072,876

(22) Filed: Mar. 4, 2005

Related U.S. Application Data
(60) Provisional application No. 60/550,643, filed on Mar. 5, 2004.

(51) Int. Cl. H04J 3/00

(52) U.S. Cl. 370/350; 370/503

(57) ABSTRACT

A system locally synchronizes a plurality of mobile mobile devices. The system includes a computer device in communication with a network, a first mobile device in communication with the network, and a second mobile device in communication with the network. The first and second mobile devices and the computer device have an installed communication application eliminating predetermined communication steps between the first mobile device and the computer device through the network and between the second mobile device and the computer device through the network.

### REFERENCE TO A PRIOR APPLICATION

This application claims the benefit of U.S. Provisional Application No. 60/550,643, filed Mar. 5, 2004.

### FIELD OF INVENTION

The present invention relates to a system for synchronizing mobile devices, and more specifically, to a system for locally synchronizing a group of mobile devices with out the assistance of a computer system external to the group of mobile devices.

### BACKGROUND OF THE INVENTION

When mobile devices are programmed to be used in a business environment, the normal communications and business application rules require communications to a peer/host computer for many business purposes. If the there is a quantity of mobile devices concentrated in a geographic location (e.g., office, warehouse, vehicle garage) and there are multiple geographic locations throughout any of the territorial boundaries (e.g., towns, cities, counties, states), a need exists for efficient network communication across all mobile device geographic location configuration. A conventional system for handling network communications across all mobile device geographic location configurations may disadvantageously generate redundant network traffic between the mobile devices or require unnecessary hardware to accomplish this task.

For example, if there are 250 mobile devices in one location, there may be 250 independent conversations from each mobile device to a single host/peer computer. If the 250 mobile devices are programmed to communicate via a dial-up communication session, there may be 250 dial-up phone calls, at least some of which are redundant or unnecessary. Further, if there are 50 mobile devices in one location, there may be a computer system that controls the mobile devices to synchronize data across the group.

### SUMMARY OF THE INVENTION

A system locally synchronizes a plurality of mobile Devices. The system includes a computer device in communication with a network, a first mobile device in communication with the network, and a second mobile device in communication with the network. The first and second mobile devices and the computer device have an installed communication application eliminating predetermined communication steps between the first mobile device and the computer device through the network and between the second mobile device and the computer device through the network.

A computer program product locally synchronizes a plurality of mobile devices. The computer program product includes: a first instruction for communicating between a first mobile device and a network; a second instruction for communicating between a second mobile device and the network; a third instruction for communicating between a computer device and the network; a fourth instruction for installing a communication application on the first mobile device; a fifth instruction for installing the communication application on the second mobile device; a sixth instruction for eliminating predetermined communication steps between the first mobile device and the computer device, the function of the predetermined communication steps being performed by the communication application on the first mobile device; and a seventh instruction for eliminating predetermined communication steps between the second mobile device and the computer device, the function of the predetermined communication steps being performed by the communication application on the second mobile device.

### BRIEF DESCRIPTION OF THE DRAWINGS

The foregoing and other features of the present invention will become apparent to the one skilled in the art to which the present invention relates upon consideration of the following description of the invention with reference to the accompanying drawings, wherein:

FIG. 1 schematically represents three basic mobile device group configurations within a system in accordance with the present invention;

FIG. 2 schematically represents communication locally managed by a Mobile Device Group Computer;

FIG. 3 schematically represents business communication between a mobile device and a Mobile Device Group Computer;

FIG. 4 schematically represents system and business application specific communication between a group of mobile devices and a Master System Computer;

FIGS. 5a and 5b schematically represents local synchronization between a first mobile device and a second mobile device; and

FIG. 6 schematically represents arbitration for establishing a first mobile device and a priority sequence for other mobile devices in a group.

### DESCRIPTION OF AN EXAMPLE EMBODIMENT

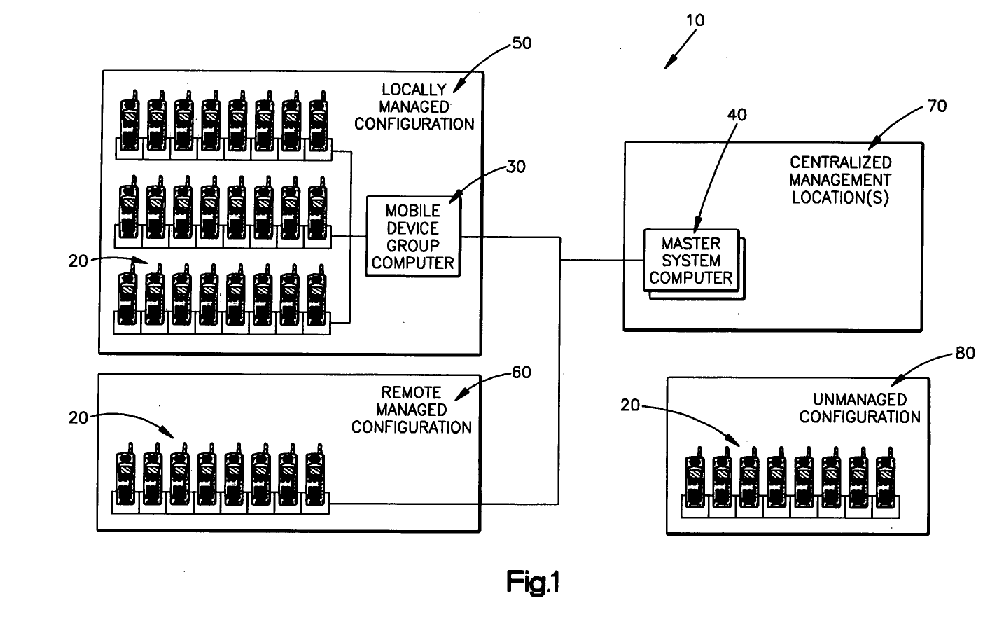

In a mobile device system 10, individual mobile devices 20 may be managed by a specific set of business rules. The specific set of business rules may require common information (i.e., software applications, user profiles, mobile device passwords, site configuration data, network configuration data, etc.) to be collected from a mobile device or a placed in the mobile device. The method of collecting or placing data on the mobile device may determine a type of configuration a group of mobile devices (FIG. 1). A system 10 in accordance with the present invention may include three basic configurations in which a group of mobile devices may be categorized.

A first locally managed configuration 50 may consist of two or more mobile devices 20 communicating to a mobile device group computer 30. The mobile device group computer 30 may be an interface between the group of mobile devices and a master system computer 40. In the locally managed configuration 50, network utilization by the group of mobile devices may not impact system designers or operators. The business information may transferred between the mobile devices 20 and the mobile device group computer 30 may or may not be transferred via a local synchronization process.

A second remotely managed configuration 60 may consist of two or more mobile devices 20 communicating to a master system computer 40. In the remotely managed configuration 60, network utilization may impact overall system performance because communication between the remote managed configuration 60 and the master system computer 40 is typically a public switched telephone network (PSTN) with variable data bandwidth (1200 baud to 56K baud) depending on a number of sites and PSTN network variables. Other telecommunication network technologies (i.e. IDSN, T1, Frame Relay) may also be utilized, but typically are not cost effective in geographic locations where the group of mobile devices reside. The quantity of mobile devices in this configuration 60 may impact mobile system performance due to limited network bandwidth. However, mobile device local synchronization may advantageously reduce the amount of data on the network by performing information propagation among the mobile devices 20 after one mobile device communicates with the master system computer 40.

The master system computer 40 may be located in a centralized management location 70 with mobile devices 20 located in multiple geographic locations (e.g, towns, cities, counties) having the locally managed configuration 50 or the remotely managed configuration 60. The master system computer 40 is optional depending on the quantity of geographic locations.

A third unmanaged configuration 80 may include a group of mobile devices 20 having the ability to communicate with each other via a local network. Business information may be propagated between all the mobile devices 20 for maintaining identical information. In this configuration 80, if the group of mobile devices 20 may be part of a larger non connected system, system information may be entered into the group via an external network with removable media (e.g. Compact Flash, SD memory, memory stick, etc.).

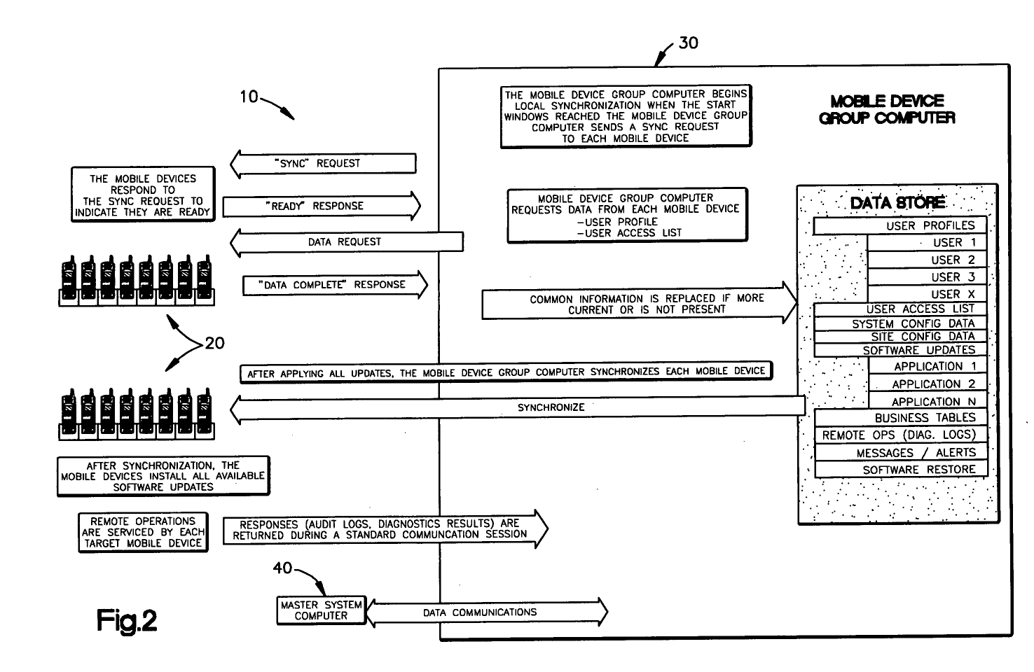

FIG. 2 illustrates a represents synchronization of the mobile devices 20 having a mobile device group computer 30 in the locally managed configuration 50. The mobile device group computer 30 may initiate a synchronization request to the mobile devices 20. A mobile device 20 may respond with a ready response. Data from the mobile device group computer 30 may then be sent to the mobile device 20. The amount and type of data depends upon business rules of the mobile device system. When data has been received (if installed or made active), the mobile device 20 may respond with an acknowledgement to the mobile device group computer 30. Communication between one mobile device 20 and the mobile device group computer 30 may be asynchronous and may occur concurrently or sequentially.

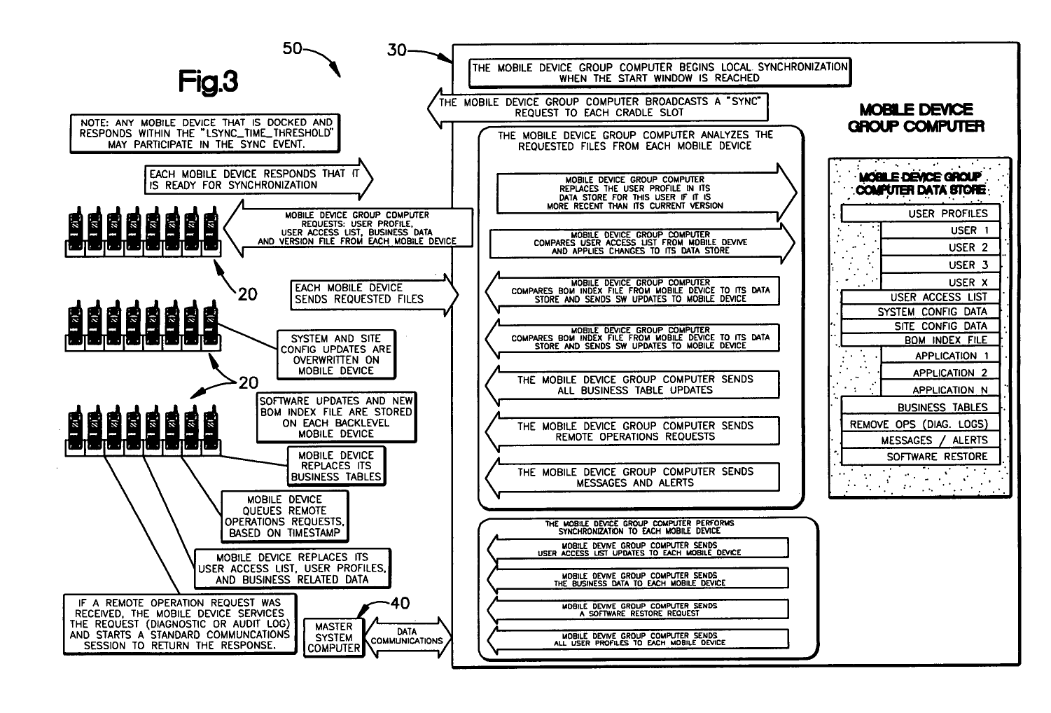

FIG. 3 illustrates a representative set of business information exchanged between a mobile device 20 and mobile device group computer 30. The business information shown FIG. 3 is typical of categories which may be found in a mobile device system requiring an entire group to have the same business information configuration 50.

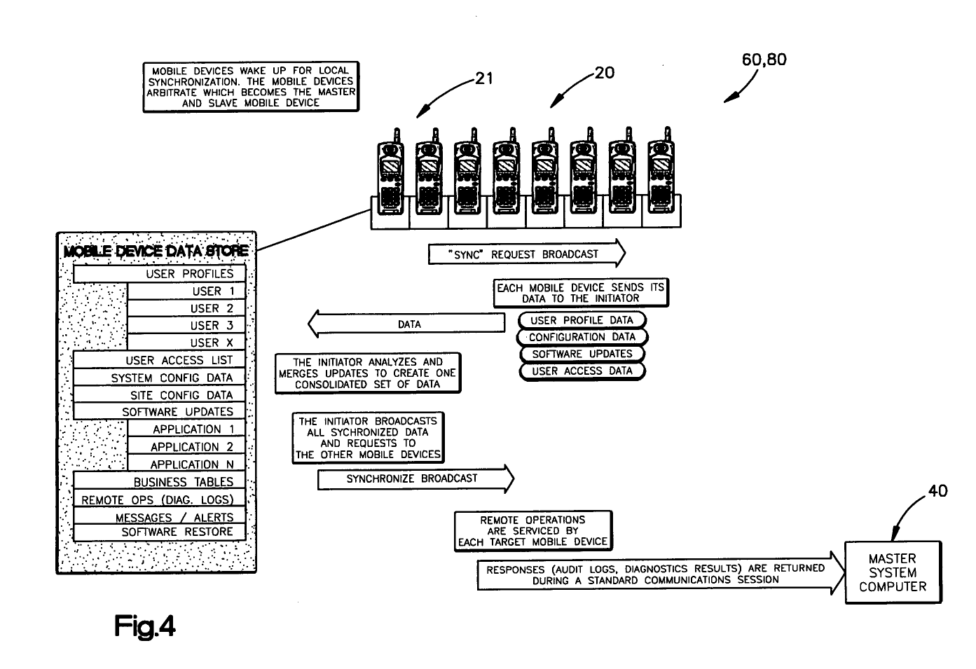

FIG. 4 illustrates local synchronization for a group of mobile devices 20 having the remotely managed configuration 60 or the unmanaged configuration 80. Communication begins with a computer instruction from the a first mobile device 21 to synchronize with the other mobile devices 20 through the network. The other mobile devices may be programmed to listen for a request to synchronize. When the other mobile devices 20 have received a request to synchronize, the other mobile devices may begin sending business specific information to the first mobile device 21. The first mobile device 21 may repeat a request to synchronize until all the responding mobile devices 20 in the group have participated within a specified program time period. When a request to synchronize has been completed for the group, the first mobile device 21 may analyze the business information collected and create one view of the data to be sent to the all the participating mobile devices 20 for a given communication session.

Frequency of communication sessions between a first mobile device 21 and a group of mobile devices 20 may be controlled by mobile system design and operation business rules. The first mobile device 21 may be any device within the group of mobile devices 20 with capability to initiate synchronization.

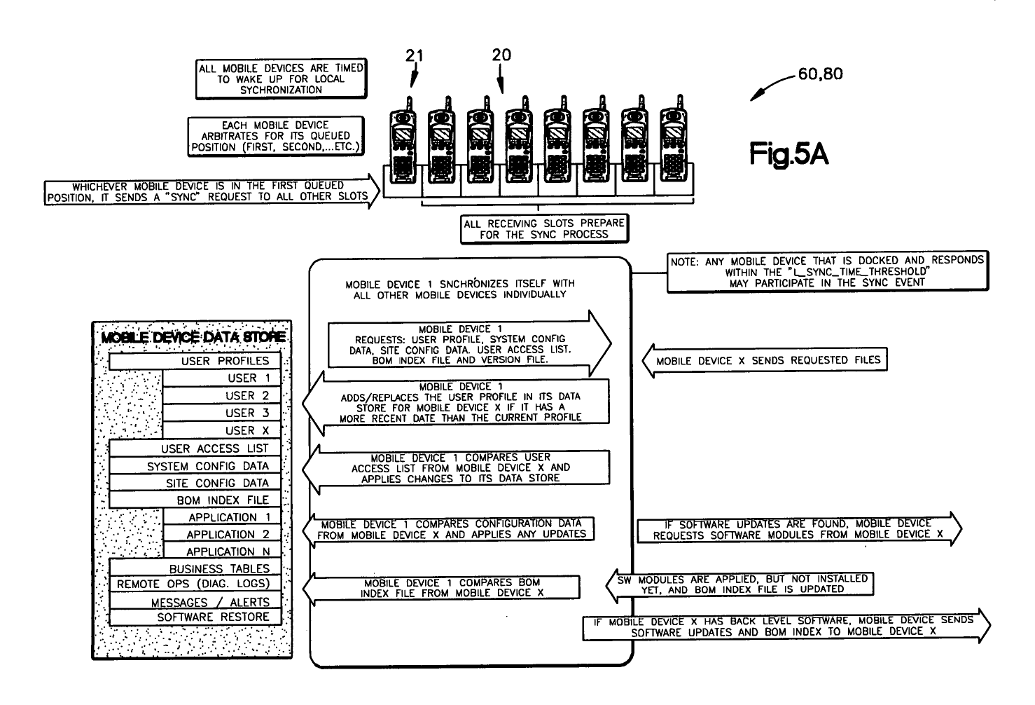

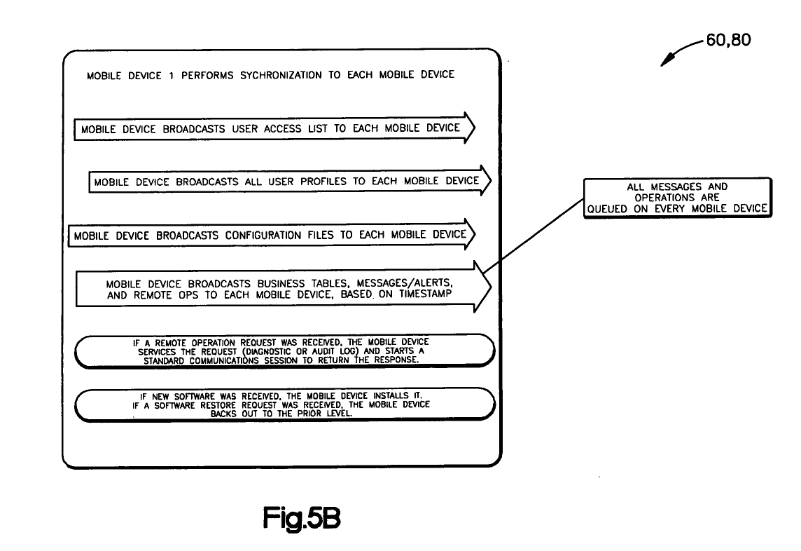

FIG. 5a and FIG. 5b illustrate a representative set of business information exchanged between a mobile device 20 and mobile device group computer 30. The business information shown in FIG. 5a is typical of the categories a mobile device system that requires all mobile devices 20 to have an identical business information configuration.

The difference between remotely managed configuration 60 and the unmanaged configuration 80 lies in the business rules for communication between the first mobile device 21 and a master system computer 40. This allows for the mobile devices 20 within a group to be automatically updated without human intervention. FIG. 5b illustrates typical business information propagated to a group of mobile devices 20 subsequent to creation of one view by the first mobile device 21.

An example computer program product in accordance with the present invention locally synchronizes a plurality of mobile devices 20 where a geographic location requires communication to a master system computer 40 or between the mobile devices. The computer program product may include: a first instruction for communicating between a first mobile device 20 and a network, a second instruction for communicating between a second mobile device 20 and the network, a third instruction for communicating between the first mobile device and the second mobile device to create an inventory of devices that participate in a communication session, a fourth instruction for communicating between the first mobile device 20 and the second mobile device 20, the fourth instruction including recent information propagated to the plurality of mobile devices, a fifth instruction for establishing a mobile device 20 as a group master 21 and a mobile device as a slave, a sixth instruction for creating data to propagate from the group master 21 to remaining mobile devices, a seventh instruction for propagating data from the group master to the slave, an eight instruction for collecting mobile device configuration inventory information, and a ninth instruction for distributing the mobile device configuration information to the mobile devices.

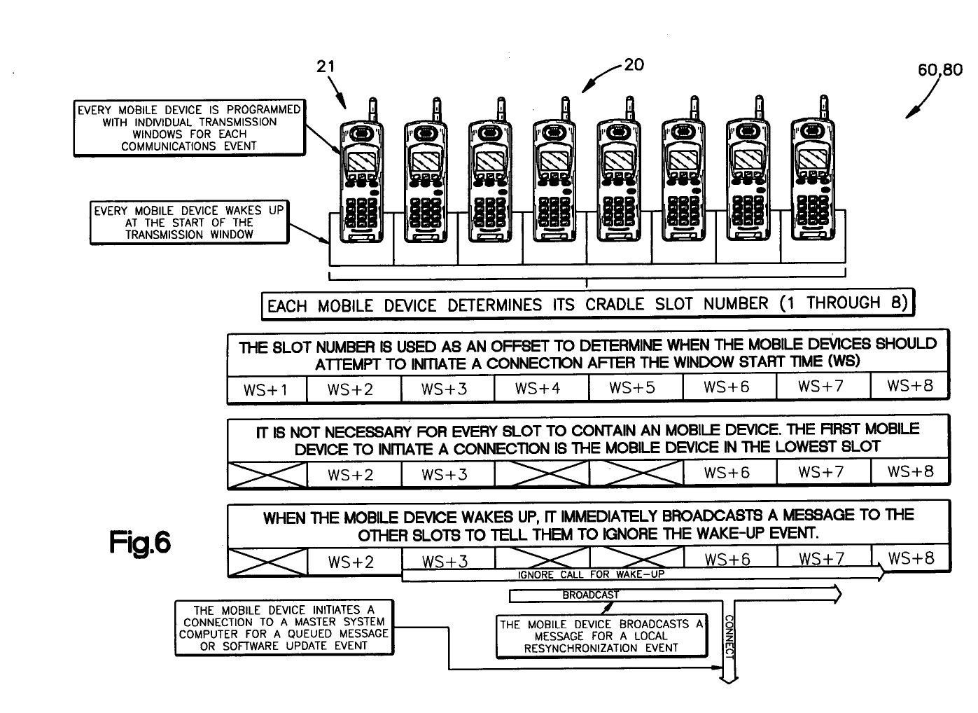

FIG. 6 illustrates arbitration for determining initiation for a first mobile device 21. The arbitration may be based on a hardware solution located at the mobile device 21 in a communication cradle. Cradle slots may provide priority for determining a first mobile device 21.

A non-hardware approach may determine a first mobile device 21 in a mobile device group. Additional arbitration may include, but is not limited to, each mobile device 20 broadcasting a synchronization time with a computer program determining an earliest synchronization time for the group of mobile devices 20. The arbitration may be used with a mobile device 20 communicating through a communication cradle or via radio frequency (e.g. Bluetooth, WiFI, etc.).

In order to provide a context for the various aspects of the present invention, the following discussion is intended to provide a brief, general description of a suitable computing environment in which the various aspects of the present invention may be implemented. While the invention has been described above in the general context of computer-executable instructions of a computer program that runs on a computer, those skilled in the art will recognize that the invention also may be implemented in combination with other program modules.

Generally, program modules include routines, programs, components, data structures, etc. that perform particular tasks or implement particular abstract data types. Moreover, those skilled in the art will appreciate that the inventive methods may be practiced with other computer system configurations, including single-processor or multiprocessor computer systems, minicomputers, mainframe computers, as well as personal computers, hand-held computing devices, microprocessor-based or programmable consumer electronics, and the like. The illustrated aspects of the invention may also be practiced in distributed computing environments where tasks are performed by remote processing devices that are linked through a communications argument model. However, some, if not all aspects of the invention can be practiced on stand-alone computers. In a distributed computing environment, program modules may be located in both local and remote memory storage devices.

An exemplary system for implementing the various aspects of the invention includes a conventional server computer, including a processing unit, a system memory, and a system bus that couples various system components including the system memory to the processing unit. The processing unit may be any of various commercially available processors. Dual microprocessors and other multi-processor architectures also can be used as the processing unit. The system bus may be any of several types of bus structure including a memory bus or memory controller, a peripheral bus, and a local bus using any of a variety of conventional bus architectures. The system memory includes read only memory (ROM) and random access memory (RAM). A basic input/output system (BIOS), containing the basic routines that help to transfer information between elements within the server computer, such as during start-up, is stored in ROM.

The server computer further includes a hard disk drive, a magnetic disk drive, e.g., to read from or write to a removable disk, and an optical disk drive, e.g., for reading a CD-ROM disk or to read from or write to other optical media. The hard disk drive, magnetic disk drive, and optical disk drive are connected to the system bus by a hard disk drive interface, a magnetic disk drive interface, and an optical drive interface, respectively. The drives and their associated computer-readable media provide nonvolatile storage of data, data structures, computer-executable instructions, etc., for the server computer. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, may also be used in the exemplary operating environment, and further that any such media may contain computer-executable instructions for performing the methods of the present invention.

A number of program modules may be stored in the drives and RAM, including an operating system, one or more application programs, other program modules, and program data. A user may enter commands and information into the server computer through a keyboard and a pointing device, such as a mouse. Other input devices (not shown) may include a microphone, a joystick, a game pad, a satellite dish, a scanner, or the like. These and other input devices are often connected to the processing unit through a serial port interface that is coupled to the system bus, but may be connected by other interfaces, such as a parallel port, a game port or a universal serial bus (USB). A monitor or other type of display device is also connected to the system bus via an interface, such as a video adapter. In addition to the monitor, computers typically include other peripheral output devices (not shown), such as speaker and printers.

The server computer may operate in a networked environment using logical connections to one or more remote computers, such as a remote client computer. The remote computer may be a workstation, a server computer, a router, a peer device or other common network node, and typically includes many or all of the elements described relative to the server computer. The logical connections include a local area network (LAN) and a wide area network (WAN). Such networking environments are commonplace in offices, enterprise-wide computer networks, intranets and the internet.

When used in a LAN networking environment, the server computer is connected to the local network through a network interface or adapter. When used in a WAN networking environment, the server computer typically includes a modem, or is connected to a communications server on the LAN, or has other means for establishing communications over the wide area network, such as the internet. The modem, which may be internal or external, is connected to the system bus via the serial port interface. In a networked environment, program modules depicted relative to the server computer, or portions thereof, may be stored in the remote memory storage device. It will be appreciated that the network connections shown are exemplary and other means of establishing a communications link between the computers may be used.

In accordance with the practices of persons skilled in the art of computer programming, the present invention has been described with reference to acts and symbolic representations of operations that are performed by a computer, such as the server computer, unless otherwise indicated. Such acts and operations are sometimes referred to as being computer-executed. It will be appreciated that the acts and symbolically represented operations include the manipulation by the processing unit of electrical signals representing data bits which causes a resulting transformation or reduction of the electrical signal representation, and the maintenance of data bits at memory locations in the memory system (including the system memory, hard drive, floppy disks, and CD-ROM) to thereby reconfigure or otherwise alter the computer system's operation, as well as other processing of signals. The memory locations where such data bits are maintained are physical locations that have particular electrical, magnetic, or optical properties corresponding to the data bits.

It will be understood that the above description of the present invention is susceptible to various modifications, changes and adaptations, and the same are intended to be comprehended within the meaning and range of equivalents of the appended claims. The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

1. A system for locally synchronizing a plurality of mobile devices, said system comprising:
a computer device in communication with a network;
a first mobile device in communication with the network; and
a second mobile device in communication with the network,
said first and second mobile devices and said computer device having an installed communication application eliminating predetermined communication steps between said first mobile device and said computer device through the network and between said second mobile device and said computer device through the network.

2. The system as set forth in claim 1 wherein said first mobile device transmits a “Ready” communication to said computer device.

3. The system as set forth in claim 1 wherein said computer device requests data from said first mobile device.

4. The system as set forth in claim 1 wherein said computer device synchronizes software applications of said first mobile device and said second mobile device.

5. The system as set forth in claim 1 wherein said computer device is a third mobile device designated a group master for synchronizing said first mobile device with said second mobile device.

6. A computer program product for locally synchronizing a plurality of mobile devices, said computer program product comprising:
a first instruction for communicating between a first mobile device and a network;
a second instruction for communicating between a second mobile device and the network;
a third instruction for communicating between a computer device and the network;
a fourth instruction for installing a communication application on the first mobile device;
a fifth instruction for installing the communication application on the second mobile device;
a sixth instruction for eliminating predetermined communication steps between the first mobile device and the computer device, the function of the predetermined communication steps being performed by the communication application on the first mobile device; and
a seventh instruction for eliminating predetermined communication steps between the second mobile device and the computer device, the function of the predetermined communication steps being performed by the communication application on the second mobile device.

7. The computer program product as set forth in claim 6 further including an eighth instruction for transmitting a “Ready” communication from the first mobile device to the computer device.

8. The computer program product as set forth in claim 6 further including an eighth instruction for requesting data from the first mobile device by the computer device.

9. The computer program product as set forth in claim 6 wherein the computer device is a third mobile device.
